(19) United States
(12) Patent Application Publication
(10) Pub. No.: US 2020/0094538 A1
(43) Pub. Date: Mar. 26, 2020

(54) SUBSTRATE STRIPPING METHOD BY TRANSFER OF A THERMOPLASTIC POLYMER SURFACE FILM

(71) Applicant: COMMISSARIAT À L'ÉNERGIE ATOMIQUE ET AUX ÉNERGIES ALTERNATIVES, Paris (FR)

(72) Inventors: Pierre Montmeat, Grenoble Cedex 09 (FR); Frank Fournel, Grenoble Cedex 09 (FR)

(21) Appl. No.: 16/578,737

(22) Filed: Sep. 23, 2019

(30) Foreign Application Priority Data
Sep. 24, 2018 (FR) 1858682

(51) Int. Cl. B32B 37/00

(52) U.S. Cl. CPC B32B 37/025

(57) ABSTRACT

A method of stripping a first substrate (1) to remove a first surface film (2) from it made of a thermoplastic polymer, the first surface film (2) having a first bond energy with the first substrate (1) at a first interface (3). The method comprising the following steps: bringing the first substrate (1) into contact with a second substrate (4) with a second surface film (5) made of a thermoplastic polymer, the second surface film (5) having a second bond energy with the second substrate (4) that is higher than the first bond energy, the contact being made through first and second surface films, formation of an assembly by bonding of the first and second surface films (2, 5) done such that the first and second surface films have a third bond energy higher than the first bond energy, separation of the assembly at the first interface (3).

### CROSS-REFERENCE TO RELATED APPLICATIONS

This application claims priority from French Patent Application No. 1858682 filed on Sep. 24, 2018. The content of this application is incorporated herein by reference in its entirety.

### TECHNICAL FIELD

The field of the invention is microelectronics, and more particularly stripping of a substrate to remove a surface film from it.

### STATE OF PRIOR ART

In microelectronics, many processes make temporary use of surface layers that then have to be removed from a substrate when the process is complete. This is the case of polymer films, used for example in photolithography.

In general, the substrate is stripped chemically by dissolution of the surface layer by means of solvents, bases or acids or by plasma assisted etching.

The substrate can also be stripped by peeling, using another adhesive polymer film (for example the film marketed under the tradename 3M™ Wafer De-Taping Tape 3305) and capable of using fairly complex spreading and removal machines.

### PRESENTATION OF THE INVENTION

The purpose of the invention is to propose a stripping method that does not make use of aggressive or toxic solutions, while remaining easy to use.

To achieve this, the invention relates to a method of stripping a first substrate to remove a first surface film from it made of a thermoplastic polymer, the first surface film having a first bond energy with the first substrate at a first interface. The method includes bringing the first substrate into contact with a second substrate having a second surface film made of a thermoplastic polymer, the second surface film having a second bond energy with the second substrate, the second bond energy being higher than the first bond energy. The method continues with bringing the first substrate and the second substrate into contact through the first and second surface films and with the formation of an assembly by means of bonding first the and second surface films done such that the first and second surface films have a third bond energy higher than the first bond energy. The method terminates with separation of the assembly at the first interface.

Some preferred but non-limitative aspects of this method are as follows:
the first and second surface films are bonded at a temperature higher than the vitreous transition temperature of the thermoplastic polymer of each of the first and second surface films;
the chemical nature of the thermoplastic polymer of the second surface film is identical to the chemical nature of the thermoplastic polymer of the first surface film;
it also comprises a first preliminary step of annealing the first substrate coated with the first surface film at a first temperature and a second preliminary step of annealing the second substrate coated with the second surface film at a second temperature higher than the first temperature;
it also comprises a first preliminary step in which the first substrate is coated by the first surface film at the first interface and a second preliminary step in which the second substrate is coated by the second surface film at a second interface, the first substrate before coating having a first surface roughness on the side of the first interface, the second substrate before coating having a second surface roughness on the side of the second interface, the second surface roughness being higher than the first surface roughness;
the second surface film lies on an adhesive layer supported by the second substrate;
the first surface film lies on an anti-adhesive layer supported by the first substrate;
the second bond energy is at least twice, and preferably at least five times higher than, the first bond energy;
separation of the assembly takes place at ambient temperature.

### BRIEF DESCRIPTION OF THE DRAWINGS

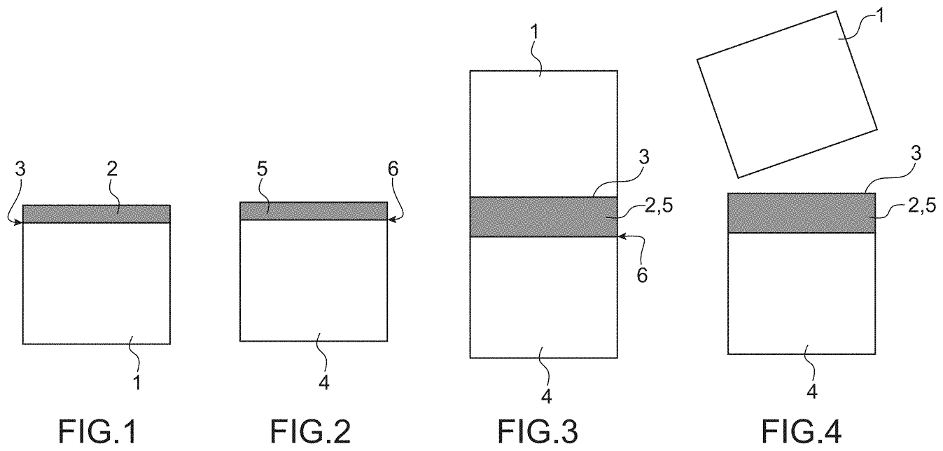

Other aspects, purposes, advantages and characteristics of the invention will become clear after reading the following detailed description of preferred embodiments of the invention, given as non-limitative examples, with reference to the appended drawings on which FIGS. 1 to 4 represent successive steps in a stripping method according to one possible embodiment of the invention.:

### DETAILED PRESENTATION OF PARTICULAR EMBODIMENTS

With reference to FIG. 1, the invention aims at a method of stripping a first substrate 1 to remove a first thermoplastic polymer surface film 2 from it. The first surface film 2 has a first bond energy E1 with the first substrate 1 at a first interface 3. In the framework of this presentation, a bond energy may for example be measured using the double lever method with imposed displacement introduced in the article by W. P. Maszara et al. “Bonding of silicon wafers for silicon-on-insulator,” Journal of Applied Physics, vol. 64, No. 10, pp. 4943-4950, November 1988. This is the case particularly for the example embodiments presented below.

With reference to FIG. 2, the method includes the supply of a second substrate 4, in which said second substrate 4 also has a second surface film 5 made of a thermoplastic polymer. The second surface film 5 has a second bond energy E2 with the second substrate 4 at a second interface 6, the second bond energy E2 being more than the first bond energy E1. The second bond energy E2 is preferably at least twice, and even more preferably at least five times, higher the first bond energy E1.

With reference to FIG. 3, the method includes bringing the first substrate and the second substrate into contact through the first and second surface films, then the formation of an assembly by means of bonding the first and second surface films 2, 5. This bonding is done more particularly such that there is a third bond energy E3 between the first and second surface films higher than the first bond energy E1. The third bond energy E3 is preferably at least twice, and even more preferably at least five times, higher than the first bond energy E1.

Then with reference to FIG. 4, the method includes separation of the assembly at the interface at which the bond energy is lowest, which is in practice the first interface 3. This separation can be done at ambient temperature. It may be a mechanical separation by traction made at ambient temperature. Such a mechanical separation can be obtained by inserting a blade that will cause separation. Such a mechanical separation can also be obtained by means of a separation ring gripping the chamfer of one of the substrates and a support holding the other substrate in position by suction. Lifting the ring then induces separation at the weakest interface.

In one embodiment of the invention, the first and second surface films 2, 5 are bonded at a temperature higher than the vitreous transition temperature of the thermoplastic polymer of each of the first and second surface films. This bonding is preferably done under vacuum.

In one preferred embodiment, the chemical nature of the thermoplastic polymer of the second surface film is identical to that of the thermoplastic polymer of the first surface film. The result obtained after the bonding is a single homogeneous phase of the thermoplastic polymer, and the strong affinity between the two surfaces brought into contact associated with the low viscosity of the polymer results in a very strong bond.

The temperature can be varied so as to obtain a second bond energy higher than the first bond energy. In the framework of the preferred embodiment presented above, the method can thus comprise a first preliminary step of annealing the first substrate coated with the first surface film at a first temperature and a second preliminary step of annealing the second substrate coated with the second surface film at a second temperature higher than the first temperature.

Complementarily to or independently of this thermal control of bond energies, the surface roughness of the first and second substrates can be varied to obtain a second bond energy higher than the first bond energy. In the framework of the preferred embodiment presented above, the method can thus comprise a first preliminary step in which the first substrate is coated by the first surface film 2 at the first interface 3 and a second preliminary step in which the second substrate is coated by the second surface film 5 at the second interface 6, the first substrate before coating having a first surface roughness on the side of the first interface, the second substrate before coating having a second surface roughness on the side of the second interface, the second surface roughness being higher than the first surface roughness. For example, a preliminary operation can be performed on the second substrate to increase the surface roughness, such as an abrasion operation, for example using a diamond wheel.

Complementarily to or independently of one or both of these bond energy control techniques, the second surface film 5 may lies on an adhesive layer, for example an HMDS (Bis(trimethylsilyl)amino) layer, supported by the second substrate 4 and/or the first surface film 2 may lies on an antiadhesive layer, for example an OPTOOL™ layer, supported by the first substrate 4.

The invention thus discloses a slightly complex method of stripping the first substrate making use of a simple transfer of the first surface layer from the first substrate to the second substrate, and that does not make use any aggressive or toxic solution.

In each of the example embodiments presented below, the thermoplastic polymer of the first and second surface films is the polymer marketed by the Brewer Science company under the tradename BrewerBOND® 305.

In a first example embodiment, 40 cm of this polymer is spread on a first 200 mm diameter silicon wafer by spin coating. An annealing is done at 170° C. The bond energy is about 2 J/m². 40 cm of this same polymer is then spread on a second 200 mm diameter silicon wafer by spin coating. An annealing is done at 250° C. The bond energy is about 14 J/m². The two wafers are then bonded at 200° C. under a vacuum through the polymer interface. The transition temperature of this polymer is close to 100° C. The assembly originating from this bonding is separated at ambient temperature and 80 μm of polymer on the second silicon wafer is recovered. There is no longer any polymer on the first silicon wafer, it has been stripped.

In a second example embodiment, 40 cm of this polymer is spread on a first 200 mm diameter silicon wafer that has a roughness RMS of less than 1 nm, by spin coating. Annealing is done at 200° C. and the bond energy is about 9 J/m². 40 cm of this same polymer is then spread on a second 200 mm diameter silicon wafer that has a roughness RMS of 300 nm after abrasion using a diamond wheel, by spin coating. Annealing is done at 200° C. and the bond energy is higher than 100 J/m². The two wafers are then bonded at 200° C. under a vacuum through the polymer interface. The transition temperature of this polymer is close to 100° C. The assembly originating from this bonding is separated at ambient temperature and 80 μm of polymer on the second silicon wafer is recovered. There is no longer any polymer on the first silicon wafer, it has been stripped.

1. A method of stripping a first substrate to remove a first surface film from it, the first surface film being made of a thermoplastic polymer having a first bond energy with the first substrate at a first interface, the method including the steps of:
bringing the first substrate into contact with a second substrate having a second surface film, the second surface film being made of a thermoplastic polymer and having a second bond energy with the second substrate, the second bond energy being higher than the first bond energy, the first substrate and the second substrate being brought into contact through the first and second surface films,
forming an assembly by bonding the first and second surface films such that the first and second surface films have a third bond energy higher than the first bond energy,
separating the assembly at the first interface.

2. The method according to claim 1, wherein the bonding of the first and second surface films is performed at a temperature higher than a vitreous transition temperature of the thermoplastic polymer of each of the first and second surface films.

3. The method according to claim 1, wherein a chemical nature of the thermoplastic polymer of the second surface film is identical to a chemical nature of the thermoplastic polymer of the first surface film.

4. The method according to claim 3, further comprising a first preliminary step of annealing the first substrate coated with the first surface film at a first temperature and a second preliminary step of annealing the second substrate coated with the second surface film at a second temperature higher than the first temperature.

5. The method according to claim 3, further comprising a first preliminary step of coating the first substrate with the first surface film at the first interface and a second preliminary step of coating the second substrate with the second surface film at a second interface, the first substrate having before the first preliminary step a first surface roughness on the side of the first interface, the second substrate having before the second preliminary step a second surface roughness on the side of the second interface, the second surface roughness being higher than the first surface roughness.

6. The method according to claim 1, wherein the second surface film lies on an adhesive layer supported by the second substrate.

7. The method according to claim 1, wherein the first surface film lies on an antiadhesive layer supported by the first substrate.

8. The method according to claim 1, wherein the second bond energy is at least twice, and preferably at least five times higher than, the first bond energy.

9. The method according to claim 1, wherein separating the assembly at the first interface is performed at ambient temperature.
